(19) United States
(12) Patent Application Publication
(10) Pub. No.: US 2021/0048600 A1
(43) Pub. Date: Feb. 18, 2021

(54) LENS MODULE

(71) Applicant: AAC Optics Solutions Pte. Ltd., Singapore City (SG)

(72) Inventor: Yuchan Gao, Shenzhen (CN)

(21) Appl. No.: 16/992,024

(22) Filed: Aug. 12, 2020

(30) Foreign Application Priority Data
Aug. 15, 2019 (CN) 201921330017.8

(51) Int. Cl. G02B 7/02; G02B 13/18

(52) U.S. Cl. CPC G02B 7/026; G02B 13/18; G02B 7/021

(57) ABSTRACT

The present disclosure provides a lens module, including a lens barrel and a lens group accommodated. The lens group includes a first lens located close to an image side, the lens barrel includes a first barrel wall having a light-through hole and a second barrel wall bent and extending from the first barrel wall. The second barrel wall includes an image-side surface close to the image side. The first lens includes an optical portion for imaging, a peripheral portion formed by extending outwards from the optical portion, and a fixing portion formed by extending outwards from the peripheral portion. The fixing portion includes a first surface close to an object side, and the first surface abuts against the image-side surface. The lens module abuts against the image-side surface directly through the fixing portion of the first lens, thus it is unnecessary to dispose a stopper, which effectively saves cost.

### TECHNICAL FIELD

The present disclosure relates to optical imaging technology, in particular to a lens module.

### BACKGROUND

With a continuous development of science and technology, electronic devices are developing towards intelligence. In addition to digital cameras, portable electronic devices such as tablet computers, mobile phones, and the like are also equipped with lens modules for shooting in order to meet users' needs in taking pictures at any time.

A lens module in existing technologies includes a lens barrel, a lens group and a stopper which are accommodated in the lens barrel. The stopper is fixedly connected with the lens barrel and presses the lens group in the lens barrel.

However, the stopper and the lens barrel in the existing technologies are fixed through dispensing by glue, which is not reliable. It is required to leave glue grooves and positions on the lens barrel to match the stopper, which limits a length of a lens barrel and a mechanical back focus length. Consequently, it is easy to result in stray light on a side wall of an opening of the lens barrel. Besides, manufacturing cost is increased by pressing the lens group through the stopper.

Therefore, it is necessary to provide a new lens module to solve the above problems.

### SUMMARY

With regard to technical problems of poor reliability of a lens module due to dispensing fixing by glue between a stopper and a lens barrel and increased cost of manufacturing due to use of a stopper in a lens module in existing technologies, the present disclosure provides a more reliable and a lower-cost lens module.

A lens module, including a lens barrel having an accommodating space, and a lens group accommodated in the accommodating space. The lens group includes a first lens located close to an image side, and the lens barrel includes a first barrel wall having a light-through hole and a second barrel wall bent and extending from the first barrel wall. The second barrel wall includes an image-side surface close to the image side. The first lens includes an optical portion for imaging, a peripheral portion formed by extending outwards from the optical portion, and a fixing portion formed by extending outwards from the peripheral portion. The fixing portion includes a first surface close to an object side, and the first surface abuts against the image-side surface.

Preferably, the second barrel wall further includes an inner surface that forms the accommodating space with the first barrel wall. The image-side surface is formed by bending and extending from an end of the inner surface in a direction away from an optical axis, where the end of the inner surface is close to the image side. The peripheral portion abuts against the inner surface.

Preferably, the first surface is fixed with the image-side surface through welding.

Preferably, the first surface is fixedly connected with the image-side surface through ultrasonic welding, laser welding, friction welding or vibration welding.

Preferably, the peripheral portion includes a second surface close to the object side, a third surface close to the image side, and a fourth surface connecting the second surface and the third surface. The fixing portion is formed by extending from the fourth surface in a direction away from the optical axis.

Preferably, the lens module further includes a shielding plate accommodated in the accommodating space. The second surface abuts against the shielding plate.

Preferably, the fixing portion is formed by extending from a side of the fourth surface in a direction away from the optical axis, where the side of the fourth surface is close to the third surface. A side of the fourth surface close to the second surface abuts against the inner surface.

Preferably, the fixing portion is in a ring shape and is disposed surrounding the peripheral portion.

Compared with the existing technologies, the lens module in the present disclosure abuts against the image-side surface of the second barrel wall directly through the first surface of the fixing portion, thus a stopper is unnecessary to be disposed, which effectively saves cost. In addition, the first surface is fixed to the image-side surface of the second barrel wall through welding and stability of connection through welding is high, therefore, thrust of the lens barrel is effectively improved and stability of the lens module is increased. Besides, since no stopper is disposed, it is unnecessary to leave glue grooves and positions on the second barrel wall to match the stopper, the lens barrel may be as much shortened as possible to avoid stray light on the side wall of the opening of the lens barrel.

### BRIEF DESCRIPTION OF THE DRAWINGS

In order to illustrate technical solutions in the embodiments of the present disclosure more clearly, the drawings used in the description of the embodiments will be briefly described below. Obviously, the drawings in the following description are only some embodiments of the present disclosure. For those skilled in the art, other drawings may also be obtained in accordance with the drawings without any inventive effort.

FIG. 1 is a schematic structural view of a lens module in the present disclosure;

FIG. 2 is a schematic enlarged view of section II in FIG. 1.

### DETAILED DESCRIPTION

A clear and complete description is provided on technical solutions in embodiments of the present disclosure with reference to the drawings for the embodiments of the present disclosure. Obviously, the embodiments described are only some rather than all embodiments of the present disclosure. On the basis of the embodiments of the present disclosure, all the other embodiments obtained by those skilled in the art without any inventive effort fall into the scope of the present disclosure.

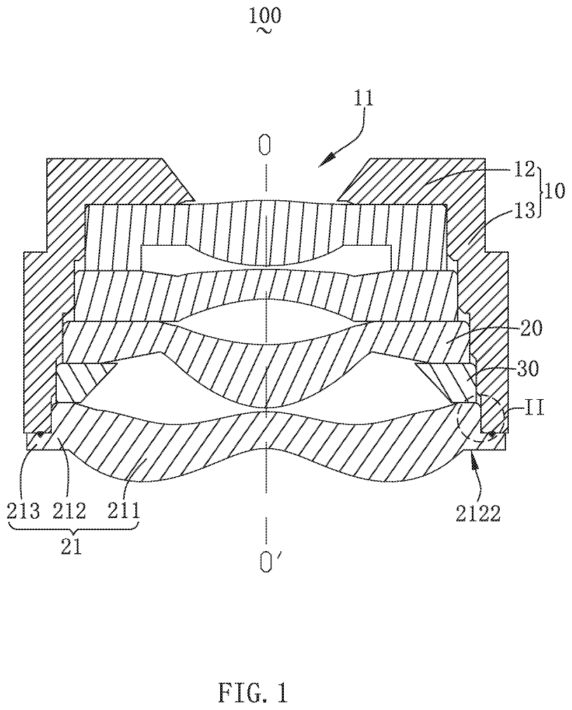

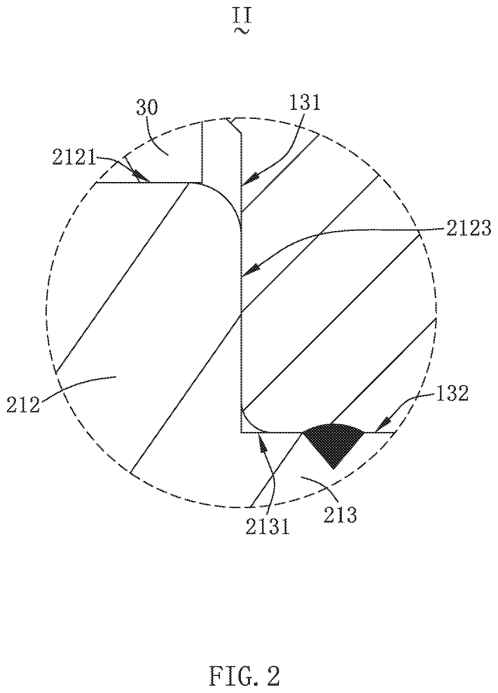

With reference to FIG. 1 and FIG. 2, the present disclosure provides a lens module 100. The lens module 100 may be applied to portable devices such as cameras and mobile phones. The lens module 100 includes a lens barrel 10 having an accommodating space, and a lens group 20 and a shielding plate 30 that are accommodated in the accommodating space.

The lens barrel 10 includes a first barrel wall 12 having a light-through hole 11 and a second barrel wall 13 bent and extending from the first barrel wall 12 to an image side. The light-through hole 11 and the accommodating space are in communication.

The second barrel wall 13 includes an inner surface 131 that forms the accommodating space with the first barrel wall 12, and an image-side surface 132 formed by bending and extending from an end of the inner surface 131 in a direction away from an optical axis OO′, where the end of the inner surface 131 is close to the image side.

The lens group 20 includes a first lens 21 located close to the image side. The first lens 21 and the lens barrel 10 are fixed through welding. The first lens 21 is fixedly connected with the lens barrel 10 through ultrasonic welding, laser welding, friction welding or vibration welding.

Specifically, the first lens 21 is fixed with the image-side surface 132 of the second barrel wall 13 through welding.

It shall be noted that in this embodiment, the lens group 20 includes four lenses. Herein, the lens close to the image side is the first lens 21. Alternatively, in other embodiments, there may be any number of lenses in the lens group 20. In this embodiment, four lenses are taken as an example for description. Besides, in this embodiment, there is one shielding plate 30 and the shielding plate 30 is disposed close to the first lens 21. Alternatively, in other embodiments, the number and positions of the shielding plate 30 may be set randomly according to practical needs. In this embodiment, one shielding plate 30 close to the first lens 21 is taken as an example for description. Besides, in another embodiment, a shielding sheet may be disposed between two neighboring lenses according to practical needs to avoid stray light.

The first lens 21 includes an optical portion 211 for imaging, a peripheral portion 212 formed by extending outwards from the optical portion 211, and a fixing portion 213 formed by extending outwards from the peripheral portion 212. The fixing portion forms a stepped structure with the peripheral portion 212 and correspondingly abuts against the lens barrel 10. The fixing portion 213 is fixed with the image-side surface 132 through welding. The fixing portion 213 includes a first surface 2131 close to an object side, and the first surface 2131 is fixed with the image-side surface 132 through welding. Specifically, the first surface 2131 is fixedly connected with the image-side surface 132 through ultrasonic welding, laser welding, friction welding or vibration welding.

The peripheral portion 212 includes a second surface 2121 close to the object side, a third surface 2122 close to the image side, and a fourth surface 2123 connecting the second surface 2121 and the third surface 2122. The second surface 2121 correspondingly abuts against the shielding plate 30. The fixing portion 213 is formed by extending from the fourth surface 2123 in a direction away from the optical axis OO′.

The fixing portion 213 is formed by extending from a side of the fourth surface 2123 in a direction away from the optical axis OO′, where the side of the fourth surface is close to the third surface 2122, and a side of the fourth surface 2123 close to the second surface 2121 abuts against the inner surface 131. The first surface 2131 and the fourth surface 2124 are connected.

It shall be noted that in this embodiment, the fixing portion 213 is in a ring shape and is disposed surrounding the peripheral portion 212, thus there is a larger welding area between the first lens 21 and the lens barrel 10, which improves stability of connection between the first lens 21 and the lens barrel 10. Preferably, a central axis of the fixing portion 213 and the optical axis OO′ are the same line, thus every side of the fixing portion 213 may be welded well with the lens barrel 10, which effectively improves stability of connection. Alternatively, in other embodiments, the fixing portion 213 may be in any shape and structure. In order to save materials, the fixing portion 213 may be in a segmented structure. For example, the fixing portion 213 may be in an arc shape and there are a plurality of fixing portions. The plurality of fixing portions 213 in the arc shape may be disposed in an annular array surrounding the peripheral portion 212, and thus may not only be welded with the lens barrel 10, but also save materials.

It may be appreciated that by fixing the first lens 21 with the lens barrel 10 through welding, a stopper is not required, thus cost is effectively saved. In addition, because no stopper is required, it is unnecessary to leave glue grooves and positions on the lens barrel 10 to match the stopper, therefore, the lens barrel 10 may be as much shortened as possible to avoid stray light on the side wall of the opening of the lens barrel. Besides, the peripheral portion 212 of the first lens abuts both with the inner surface 131 and the shielding plate 30, which facilitates assembling and centralization of the lens group 20. Further, because the fixing portion 213 and the lens barrel 10 are fixed through welding, the connection is reliably stable, thereby effectively improving thrust of the lens barrel 10, strengthening stability of the lens module 100 and reducing possibility of falling.

Compared with existing technologies, the lens module in the present disclosure abuts against the image side of the second barrel wall directly through the first surface of the fixing portion, thus it is unnecessary to dispose a stopper, which effectively saves cost. In addition, the first surface is fixed to the image-side surface of the second barrel wall through welding and stability of connection through welding is high, thrust of the lens barrel is effectively improved and stability of the lens module is increased. Besides, since no stopper is disposed, it is unnecessary to leave glue grooves and positions on the second barrel wall to match the stopper. Further, the lens barrel may be as much shortened as possible to avoid stray light on the side wall of the opening of the lens barrel.

The above-described are only embodiments of the present disclosure. It shall be noted that for those skilled in the art, an improvement may be performed without departing from the creative concept of the present disclosure, but the improvement falls into the protection scope of the present disclosure.

What is claimed is:

1. A lens module, comprising a lens barrel having an accommodating space, and a lens group accommodated in the accommodating space, the lens group comprising a first lens located close to an image side, the lens barrel comprising a first barrel wall having a light-through hole and a second barrel wall bent and extending from the first barrel wall, and the second barrel wall comprising an image-side surface close to the image side, wherein the first lens comprises an optical portion for imaging, a peripheral portion formed by extending outwards from the optical portion, and a fixing portion formed by extending outwards from the peripheral portion, the fixing portion comprises a first surface close to an object side, and the first surface abuts against the image-side surface.

2. The lens module according to claim 1, wherein the second barrel wall further comprises an inner surface that forms the accommodating space with the first barrel wall, the image-side surface is formed by bending and extending from an end of the inner surface close to the image side in a direction away from an optical axis, and the peripheral portion abuts against the inner surface.

3. The lens module according to claim 2, wherein the first surface is fixed with the image-side surface through welding.

4. The lens module according to claim 3, wherein the first surface is fixedly connected with the image-side surface through ultrasonic welding, laser welding, friction welding or vibration welding.

5. The lens module according to claim 2, wherein the peripheral portion comprises a second surface close to the object side, a third surface close to the image side, and a fourth surface connecting the second surface and the third surface, and the fixing portion is formed by extending from the fourth surface in a direction away from the optical axis.

6. The lens module according to claim 5, wherein the lens module further comprises a shielding plate accommodated in the accommodating space, and the second surface abuts against the shielding plate.

7. The lens module according to claim 5, wherein the fixing portion is formed by extending from a side of the fourth surface close to the third surface in a direction away from the optical axis, and a side of the fourth surface close to the second surface abuts against the inner surface.

8. The lens module according to claim 1, wherein the fixing portion is in a ring shape and is disposed surrounding the peripheral portion.
